(19) United States
(12) Patent Application Publication
(10) Pub. No.: US 2009/0185555 A1
(43) Pub. Date: Jul. 23, 2009

(54) METHOD AND DEVICE FOR PROVIDING MULTIMEDIA DATA WHEN ESTABLISHING A TELEPHONE CALL

(75) Inventors: Cyril HUE, Issy Les Moulineaux (FR); Claire Bazin, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/279,640

(22) PCT Filed: Feb. 15, 2007
(86) PCT No.: PCT/FR07/50802

§ 371 Date: Nov. 13, 2008

(30) Foreign Application Priority Data
Feb. 16, 2006 (FR) 0650553

(51) Int. Cl. H04L 12/66

(52) U.S. Cl. 370/352

(57) ABSTRACT

The invention concerns a method and a device for providing multimedia data when setting up a telephone call. The terminal being connected via Internet to a platform (9) for providing multimedia data, a call is transmitted (4) to a call server (5) which blocks the call, then notifies the call event (6) to the platform (9). The latter downloads multimedia data into the terminal (3) when the multimedia data are downloaded. The invention is in particular useful for providing additional services when setting up phone calls.

The present invention pertains to a method and device for providing multimedia data when establishing a telephone call. In particular, it applies to providing additional services to users at the time that telephone calls are established.

Telephony services are continuing to expand. It is important for an operator to be capable of offering increasingly diversified, high-performance services. Users, meanwhile, expect to benefit from increasingly numerous means of communication and associated services. The combination of conventional telephony services and Internet services may afford users many advantages. In this manner, whenever a subscriber to a fixed or mobile telephony service hears the ringtone of a call, he may wish to know the identity of the calling party, but may also want to have other information. In particular, this information may, for example, be a detailed business card of the calling party, the minutes of a preceding meeting held between the called party and the calling party, or a video clip of a conference or presentation concerning them. All of this information may also be available in the form of webpages, or any other sort of multimedia information presentations.

The implementation of such additional services draws upon the field of telephony, characterized by circuit-switched networks, and the field of the Internet, characterized by data packet switched networks. Most telephony terminals, fixed or mobile, are unable to handle both of these fields. Knowing the identity of the calling party provides a good example of this difficulty. Telephony terminals may display the callers' identity, generally the first and last name. However, this is only possible if the user had previously saved the name of the calling party in his terminal, alongside the calling party's telephone number. If an unknown person, or someone whose identity has not yet been saved in the terminal calls, the identity cannot be displayed on the terminal. In general, the terminal can only display the calling number. Currently available telephony services therefore remain limited, running counter to the increasing demand for services of all sorts. In particular, under the state-of-the-art technique, the services previously described when establishing a telephone call are not commonly available, or at the very least are only accessible if significant changes are made to the telephony equipment.

One purpose of the invention is, in particular, to enable the providing of additional services when establishing telephone calls in a manner suitable for existing telephony terminals. To that end, the subject of the invention is a method for providing multimedia data to a telephony terminal when establishing a telephone call, said terminal being connected by a switched packet network to a multimedia data providing platform, said call being transmitted to a call server. The server blocks the call, then notifies the platform of the call event; the platform uploads multimedia data onto the terminal, with the server unblocking the call to the terminal once the multimedia data has been uploaded.

Another subject of the invention is a device for providing multimedia data to a telephony terminal when establishing a telephone call, comprising at least one multimedia data providing platform and one call server connected to the platform via a packet-switched network. The call is transmitted to the call server, which blocks the call, then notifies the platform of the call event. The platform uploads multimedia data onto the terminal via a packet-switched network, with the server unblocking the call to the terminal once the multimedia data has been uploaded.

The invention's main advantages particularly include the fact that it is suitable for all types of telephony networks and for most telephony terminals, whether fixed or mobile, and that it requires very few or no hardware modifications to existing equipment. Other characteristics and advantages of the invention will become apparent with the help of the following description, given with reference to the attached drawings, which depict:

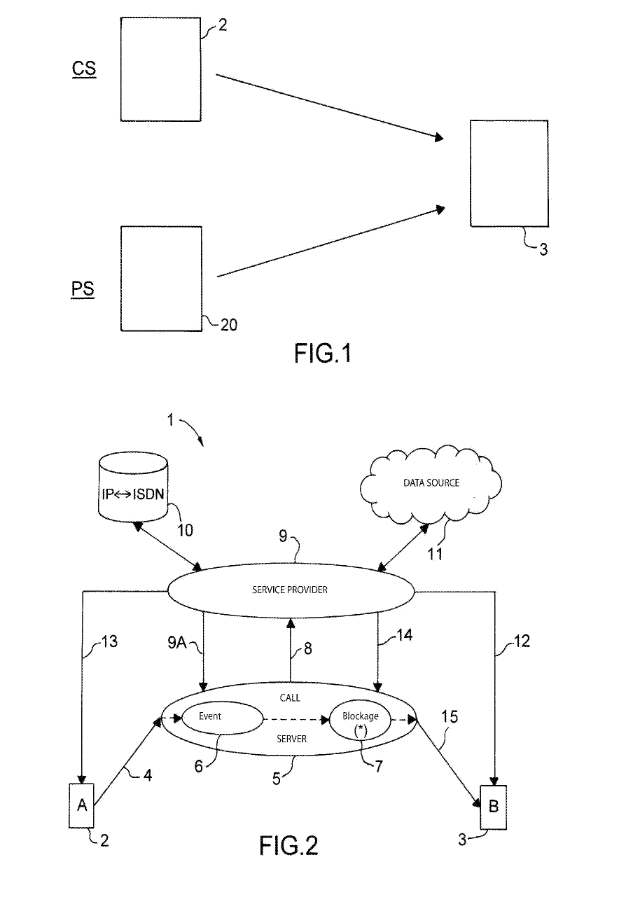

FIG. 1, an illustration of a telephony terminal in relationship with a circuit-switched network and a packet-switched network;

FIG. 2, an illustration of an example telephony communication system wherein the inventive method is implemented.

FIG. 1 depicts two networks to which a telephony terminal 3 may connect. The telephony services use a circuit-switched network CS. With this network, a user B may be called at his terminal 3 from another user's terminal 2. This network CS cannot transmit multimedia data. The user B therefore cannot make use of important additional services via this channel. In order to benefit from such services 20, he must, in particular, access the Internet network, or other packet-switched networks PS. Currently, telephony terminals cannot easily access both networks CS, PS at once. In particular, they do not enable a user to benefit from additional services when establishing a telephone call.

FIG. 2 depicts an example of a telecommunications system wherein an embodiment of the inventive method has been implemented. Within the system, a user A equipped with a telephony terminal 2 enters into communication with a user B equipped with a telephony terminal 3. The system includes a call server 5. This call server forms part of a circuit-switched network, which may be public or private. Whenever the telephone number of the called terminal 3 is dialed from the terminal 2, this number is sent to the call server, which then puts the two terminals 2, 3 into communication with one another. The system further comprises a platform 9 which manages multimedia services. The call server 5 may communicate with the platform via the packet-switched network PS, for example, via the Internet network. The platform 9 may, for example, be managed by a multimedia service provider.

Numerous users or subscribers may access it. In this context, the call server 5 is a user, among others, of the platform 9, and possesses its own network access address, in particular its own IP address for the Internet network. The platform 9 therefore provides various types of multimedia services. To that end, it accesses service providers, then dispatches these services to its subscribers or users. In the context of implementing the inventive method, the platform 9 may, for example, access a set of services. These services are, in fact, multimedia data stored within a data source 11. To facilitate the description, hereafter the data source 11 and the services that it contains will be conflated.

These services 11 are intended to be provided to users when telephone calls are established, but not necessarily so. They may be services which are already otherwise available for other uses. These services 11 may, for example, deliver the business cards of calling parties A, websites including other information, or video or audio clips, and more generally, all types of multimedia information. Furthermore, the platform 9 is connected to a database 10. This database comprises associations between the telephone numbers of the telephone terminals 2, 3 and their IP addresses, said IP (or “Internet Protocol”) addresses making it possible to route multimedia information to these terminals. Each terminal has its own IP address at a given moment. The telephone or call numbers are further known as ISDN numbers, for “Integration Service Data Network”. An ISDN number is a circuit-switched telephone network CS number used to identify the terminals 2, 3 of said network. For a mobile telephony network, the telephone numbers are further known by the abbreviation MSISDN, for “Mobile Station ISDN”. For a given network, the database 10 therefore indicates the associations between the IP addresses and ISDN or MSISDN numbers of the terminals 2, 3.

One problem for a called terminal 3 is simultaneously receiving both a telephone call from a terminal 2 via the circuit-switched network CS, and multimedia information via the packet-switched network PS. According to the invention, whenever a user A uses his terminal 2 to call the terminal 3 of another user B, the call server 5 blocks the call, then transmits the telephone number of the terminal 3 to the platform 9. Using this telephone number, the platform can recognize the IP address of the terminal 3 by means of the database 10. The platform then uploads the additional services 11 intended for the terminal 3 via a link 12 over the packet-switched network PS. Once the services 11 have been uploaded onto the terminal 3, the platform 9 informs the call server 5 via a link 14. The call server 5 then unblocks the call and initiates the ringtone of the terminal 3 in order to establish telephone communication. Upon the establishment of communication, the called party B may therefore see the previously downloaded multimedia information be displayed. The called party B may, for example, see the identity card of the calling party A displayed on the terminal 2. In this context, the platform 9 particularly corresponds to any equipment capable of processing such services 11, saving them, selecting relevant services based, for example, on the identity of the called party or his terminal, on a code sent, if applicable, by the calling party, or on a request expressed beforehand by the called party, and is capable of then sending these services to the called party, and potentially to the calling party, via the Internet network.

By way of example, a call from the terminal 2 to the terminal 3 is hereafter described, with reference to FIG. 2.

In a first step, the calling party A dials the called number of the terminal 3. A link 4 is then established between the terminal 2 and the call server 5 via the circuit-switched network CS. This call creates an event 6 within the call server, said event indicating that a call is being established between the terminal 2 and the terminal 3.

In a second step, the call server 5 takes this event 6 into account when performing at least two actions. In a first action, the server blocks the call coming from the calling terminal 2. To do so, it saves the call number in a reserved area 7. In a second action, the call server 5 notifies the platform 9 of the event 6 via the Internet network. The transmission of the event 6 is accompanied by the call number of the terminal 3. In a third step, based on this call number, the platform obtains the IP address of the terminal 3 within the database 10 which includes the associations between the IP addresses and the call numbers of the terminals. In the fourth step, the platform 9 retrieves the multimedia data to be uploaded onto the terminal 3. This data may vary from one call to another and from one user to another. At this step of the method, it may be noted that the users A, B have previously been recorded within the platform 9. More particularly, the users' profiles have been recorded. This profile may, for example, determine the data to be transmitted related to each calling or called party. This profile is not fixed; it may be updated dynamically. A memory area may, for example, be reserved within the platform for storing each user's profile. An example standard profile of a user A may, for example, indicate that the business card of that user is transmitted to called parties each time that he makes a call. The profile may also contain filters, so that the identity card is transmitted only to previously defined called parties. Here, it is assumed by way of example to be to be an identity card, but the profile may treat all types of multimedia data. The profile may also be modified dynamically, so that the calling party may modify his profile before initiating a call. In this manner, he may request that the platform transmit the minutes of a previous meeting. This also means that a user A had previously uploaded to the platform 9, by means of his terminal 2 or any other terminal, the information that he wishes to transmit. In this manner, the additional services provided may depend on the profile of the called party, and, if applicable, may also depend on the identity of the calling party or his profile

In a sixth step, the platform 9 retrieves the multimedia data corresponding to the additional services linked to the call, and uploads them to the IP address of the terminal 3. If applicable, the platform may also upload other additional services onto the terminal 2 of the calling party A. A document which is useful to both the calling party A and the called party B may thereby be uploaded onto both terminals 2, 3. Finally, the platform 9 informs the call server 5 via a notification 14 that the additional services have been uploaded. In the following step, the call server 5 releases the call saved in the reserved area 7, and activates a communication 15 with the terminal 3. The terminal 3 is then activated and produces an alarm; for example, a ringtone. When the user B activates a response, the call server establishes communication between the terminals 2, 3, which may additionally display or produce previously downloaded multimedia data. Preferably, the users A, B subscribe to a specific subscription, such as one with the service provider. Via this subscription, the users upload the data of their previously described profile, as well as multimedia data for providing additional services 11. The platform 9 may, for example, send the call server 5 a notification 9A whenever a new subscriber registers or whenever a subscriber cancels a subscription. In this manner, the call server sends notifications 8 when a call event 6 occurs only for the terminals of users A, B who have taken out a subscription for the additional services. In particular, this prevents the call server from entering into communication when every call is established, including calls for users not affected by the additional services.

The database 10 that indicates the associations between the ISDN call numbers and the IP addresses of the terminals may, for example, be located at the platform 9, for example in a presence server. It may, for example be this presence server that manages said database 10 via successive updates. In particular, whenever a user subscribes to additional services, he informs the service provider of the call number and the IP address of his terminal. The platform 9 may then supply the database 10. The structure of this database may, for example, be such that it comprises a set of pairs each formed of a call number and an IP address. For a terminal, the IP address may be fixed, but it may also be dynamic. Dynamic assignment of IP addresses particularly enables a service provider to provide services to a greater number of subscribers. As the number of IP addresses is limited, dynamic management makes it possible to successively assign to a given subscriber different IP addresses depending on a current status of a service request. The platform 9 may manage the IP addresses within the database 10 based on a global dynamic management of all IP addresses. In particular, a particular protocol for implementing the inventive method may require that a user provide his current IP address to the platform so that said platform 9 can update the database 10 accordingly.

In the preceding description of an implementation of the inventive method, it was assumed that a telephone terminal 2, 3 could additionally receive multimedia data, such as over the Internet network. GPRS mobile telephony terminals may receive such data. The inventive method, however, applies to other types of terminals. It may, in particular, be applied to fixed or mobile terminals that cannot receive multimedia data, on the condition that these terminals are associated with an Internet terminal, particularly a fixed or portable computer. For implementing the inventive method as described above, a terminal 2, 3 is, in such a case, the combination of a telephony terminal, such as a land-line telephone, and a packet-switched network terminal, such as a computer.

In one particular embodiment of the method, the platform 9 of additional services may be integrated into the call server 5, thereby forming a service extension of the call server. The telephone network may be a public or private network, particularly a corporate network, such as a PABX network.

A device for providing additional services upon the establishment of a telephone call may, for example, be composed of at least the platform 9 and a call server 5 cooperating as previously indicated, in relation with the description of FIG. 2. The database which saves the IP addresses of the call numbers of the terminals may, for example, be integrated into the platform 9. The device further comprises the data source 11 which contains the additional services. It was previously indicated that this data source 11 could be updated by the users themselves, in particular by uploading multimedia data from their terminals 2, 3. This data source 11 may also be supplied by third-party entities, which may be private or public, depending on the type of subscription. It may therefore be envisioned that a public organization may supply the data source with general-interest information, such as weather information, general information, or information on shows. A private organization could upload videoclips or music samples onto the data source 11. Some of this information, the video or audio clips, could then be displayed on a terminal whenever communication is established, such as depending on the type of description or the identity of the users, and more generally depending on their profiles. The data source 11 may also be supplied by an organization which delivers the position of the terminals 2, 3, on the condition that said terminals are equipped with a satellite positioning receiver, in particular a GPS receiver, and that the users have subscribed to a particular subscription. In such a case, the data source is dynamically supplied with the successive positions of the terminals 2, 3. Whenever the terminal 2 makes a call to the terminal 3, the positioning data of the terminal 2 may, for example, be uploaded onto the terminal 3, potentially along with other data. In this manner, whenever the call is established, the user of the terminal 3 may see the position of the terminal 2 displayed. It is possible to further envision that the position of the terminal 3 may also be uploaded onto the terminal 2 so that the user of said terminal can likewise read the position of the terminal 3 that he is calling. The data source 11 may also comprise software programs. For example, it may contain a program which acts upon the ringtone of a terminal 2, 3. In such a case, the program comprises the instructions for modifying the ringtone and a particular melody, said melody changing, for example, depending on the calling user. In this manner, the called user has the option to recognize the identity of the caller upon the establishment of the ringtone of his terminal. The ringtone may be replaced by a particular manner of vibrating.

1. A method for providing multimedia data to a telephony terminal (3) upon the establishment of a telephone call, characterized in that the terminal being connected via a packet-switched network (PS) to a multimedia data providing platform (9), and said call being transmitted (4) to a call server (5), the server (5) blocks said call and then notifies said platform (9) of the call event (6), the platform (9) uploading multimedia data onto the terminal (3), the server (5) unblocking said call to said terminal (3) once said multimedia data has been uploaded.

2. A method according to claim 1, characterized in that the notification of the call event (6) sent to the platform (9) comprises the call number of the terminal (3), said platform (9) accessing a database (10) indicating the association between the call number of the terminal (3) and its access address (IP) via the packet-switched network (PS).

3. A method according to claim 1, characterized in that the platform (9) notifies the call server (5) of the completion of the uploading of the data onto the terminal (3).

4. A method according to claim 1, characterized that the call is sent by a calling terminal (2) connected to the platform (9) via the packet-switched network (PS), said platform uploading data onto said calling terminal (2).

5. A method according to claim 1, characterized in that the platform contains a profile associated with each terminal (2, 3), the data uploading onto a terminal depending on its profile.

6. A method according to claim 1, characterized in that the multimedia data had previously been uploaded onto a data source (11).

7. A method according to claim 6, characterized in that the data is downloaded by the telephony terminals (2, 3).

8. A method according to claim 6, characterized in that the data is downloaded by a third-party entity.

9. A method according to claim 1, characterized in that the platform (9) uploads a program to modify the ringtone of the terminal (3).

10. A method according to claim 1, characterized in that a calling terminal (2) being associated with a satellite positioning receiver, the position of said calling terminal is provided to the platform (9), which uploads it onto the called terminal (3).

11. A method according to claim 1, characterized in that a called terminal (3) being associated with a satellite positioning receiver, the position of said called terminal is provided to the platform (9), which uploads it onto the calling terminal (2).

12. A method according to claim 1, characterizing that a specific subscription being provided for providing multimedia data, the platform (9) sends the call server (5) a notification (9A) upon the registration or cancellation of a subscriber, the call server sending the notifications (8) upon the occurrence of a call event (6) only for the terminals (2, 3) of the subscribers.

13. A device for providing multimedia data to a telephony terminal (3) upon the establishment of a telephone call, characterized in that it comprises at least one multimedia data providing platform (9) and a call server (5) connected to the platform via a packet-switched network (PS), the call being transmitted (4) to the call server (5), the server (5) blocking the call and then notifying the platform (9) of the call event (6), said platform (9) uploading multimedia data onto the terminal (3) via the packet-switched network (PS), the server (5) unblocking the call to the terminal (3) once the multimedia data has been uploaded.

14. A device according to claim 13, characterized in that the platform (9) comprises a database (10) indicating the association between the call number of a terminal (3) and its access address (IP) via the packet-switched network (PS), the notification of the call event (6) by the server (5) to the platform comprising the call number of the terminal (3).

15. A device according to claim 13, characterized in that the platform (9) notifies the call server (5) of the completion of the downloading of the data onto the terminal (3).

16. A device according to claim 13, characterized that the platform (9) comprises profiles associated with terminals (2, 3) and a data source (11) storing the multimedia data, the multimedia data being uploaded onto a terminal (2, 3) depending on its profile.

17. A device according to claim 13, characterized that the platform (9) is integrated into the call server (5).
